(19) United States
(12) Patent Application Publication
(10) Pub. No.: US 2015/0326305 A1
(43) Pub. Date: Nov. 12, 2015

(54) Framing Mechanism For Time-Division-Duplex OFDM Communication Systems

(71) Applicant: Metanoia Communications Inc., Hsinchu (TW)

(72) Inventors: Chun-Che Chang, Hsinchu (TW); Sam Mungall, Hsinchu (TW)

(21) Appl. No.: 14/794,677

(22) Filed: Jul. 8, 2015

Related U.S. Application Data
(63) Continuation-in-part of application No. 13/875,279, filed on May 1, 2013, now Pat. No. 9,100,091.
(60) Provisional application No. 61/641,199, filed on May 1, 2012.

(51) Int. Cl. H04B 7/26; H04L 5/00

(52) U.S. Cl. CPC H04B 7/2603; H04L 5/0007

(57) ABSTRACT

The present disclosure outlines mechanisms, systems, methods, techniques and devices that reposition a RMC symbol in a TDD frame. In one aspect, a method queues data transmission units (DTUs) for transmission in a TDD OFDM communication system, with each of the DTUs occupying a single symbol partially or fully, or multiple symbols, of a series of symbols in a TDD frame. The method also forms a management symbol for transmission in a k^{th} symbol position of the series of symbol positions, k>1. The method further transmits the symbols sequentially in the TDD frame.

### CROSS REFERENCE TO RELATED PATENT APPLICATION(S)

This is a continuation-in-part (CIP) application claiming the priority benefit of U.S. Utility patent application Ser. No. 13/875,279, filed 1 May 2013, and claiming the priority benefit of U.S. Provisional Patent Application No. 61/641,199, filed 1 May 2012. The above-identified applications are incorporated by reference in their entirety.

### BACKGROUND

1. Technical Field

The present disclosure generally relates to the field of digital communication and, more particularly, to a time-division-duplex (TDD) orthogonal frequency-division multiplexing (OFDM) communication system.

2. Description of the Related Art

In a modern point-to-point TDD OFDM communications system, such as a G.fast system that is standardized as recommendation G.9701 at the International Telecommunication Union (ITU) Telecommunication Standardization Sector (ITU-T) under the title “Fast access to subscriber terminals (G.fast)—Physical layer specification”, a time domain signal consists of a combination of upstream symbols and downstream symbols. The switching time between upstream and downstream symbols should be minimized or unnecessary data bandwidth would be wasted. The basic transmission unit in G.fast is called a “TDD frame”. A TDD frame consists of a series of symbols in one transmit direction (e.g., from point A to point B) followed by a series of symbols in the other transmit direction (e.g., from point B to point A). If the transmission is from FTU-O (i.e., central office of a service provider) to FTU-R (i.e., customer premises) this is referred to as the downstream direction. If the transmission is from FTU-R to FTU-O this is referred to as the upstream direction.

As described herein, the term “symbol position” is used to represent a specific symbol in an upstream or a downstream transmission. For example, a symbol position of 5 in a downstream transmission is the 5^{th} symbol from the beginning of the downstream transmission.

For purposes such as retransmission acknowledgment or fast on-line reconfiguration to accommodate a rapid noise change experienced on the communication channel, it is desirable to have a dedicated management channel separate from the payload (DTU carrying) channel. The name of this management channel is called the RMC (robust management channel) herein. The specific management channel symbol is called a RMC symbol. The naming of this management channel and corresponding symbol thereof is irrelevant to the inventive concept of the present disclosure, although the term “RMC” is used herein to denote a management channel having the functionality described herein. The RMC is transmitted at a fixed symbol position in upstream and downstream directions respectively and positioned within one symbol for each direction, so there is one RMC symbol upstream and one RMC symbol downstream in every TDD frame.

A RMC symbol can be a unique symbol or shares a symbol with payload data. The content of the RMC symbol could be protected by high-redundancy (e.g., low coding rate) forward error corrections (FECs) and/or high signal-to-noise ratio (SNR) margins since the RMC symbol carries critical operation and management information. It could also use a known bit-loading pattern that does not require any handshake between the FTU-R and FTU-O devices in showtime. Showtime refers to an operation state in which DTUs are transmitted.

One major function of the RMC symbol is carrying the acknowledgement (ACK) information for the retransmission mechanism, similar to the retransmission-return-channel (RRC) defined in ITU-T recommendation G.998.4. Typically in frame-based systems, management data is inserted at the beginning of transmission for each direction to align with the physical layer. However, doing so might affect the performance of the system if the processing time in the digital domain occupies a period of time for multiple symbols. An example is ITU-T G.9960 standard where the time gap between the transmission and the corresponding acknowledgement is defined as IFG (inter-frame-gap). In G.9960 a typical value of inter-frame gap (IFG) is around a time period equivalent to three to six symbols.

### SUMMARY

Various embodiments of mechanisms, systems, methods, techniques and devices that reposition a management symbol in a TDD frame are disclosed herein.

In one aspect, a method may include: queuing data transmission units (DTUs) for transmission in a time-division-duplex (TDD) orthogonal frequency-division multiplexing (OFDM) communication system, each of the DTUs occupying a single symbol partially or fully, or multiple symbols, of a series of contiguous symbols in a TDD frame; forming a management symbol, e.g., a RMC symbol, for transmission in a k^{th} symbol position of the series of symbols, k>1; and transmitting the symbols sequentially in the TDD frame.

In one embodiment, the TDD frame may include a group of contiguous OFDM symbols transmitted in a downstream direction following or followed by a group of contiguous OFDM symbols transmitted in an upstream direction.

In one embodiment, the TDD frame may further include a time gap between the group of contiguous OFDM symbols transmitted in one direction and the group of contiguous OFDM symbols transmitted in the other direction.

In one embodiment, the management symbol may contain acknowledgement information for retransmission, configuration information for physical medium dependent (PMD) layer, or both.

In one embodiment, the configuration information for PMD layer may include information related to forward error correction (FEC), bit-loading for a transmitter, bit-loading for a receiver, or any combination thereof.

In one embodiment, the management symbol may occupy a single symbol.

In one embodiment, the management symbol may include a dedicated OFDM symbol that is shared with one or more DTU(s).

In one embodiment, the method may transmit the management symbol in either or both of a downstream direction and an upstream direction once per TDD frame.

In one embodiment, the method may transmit the management symbol in the k^{th} symbol position in either or both of a downstream direction and an upstream direction in the TDD frame.

In one embodiment, the method may further include: optimizing the symbol position k for the management symbol based on various criteria or constraints such as retransmission latency and memory size. The retransmission latency is introduced when one or more DTUs are not received correctly by the receiver and needs to be transmitted again. The value k might not be unique and might be different for upstream and downstream directions respectively.

In another aspect, a communication device may include a memory unit and a processing unit. The memory unit may be configured to store data, one or more sets of instructions, or both. The processing unit may be coupled to access the memory unit, and may be configured to perform a number of operations. The operations may include: queuing DTUs for transmission in a TDD OFDM communication system, each of the DTUs occupying a single symbol partially or fully, or multiple symbols, of a series of contiguous symbols in a TDD frame; forming a management symbol, e.g., a RMC symbol, for transmission in a k^{th} symbol position of the series of symbols, k>1; and transmitting the symbols sequentially in the TDD frame.

In one embodiment, the TDD frame may include a group of contiguous OFDM symbols transmitted in a downstream direction following or followed by a group of contiguous OFDM symbols transmitted in an upstream direction with a time gap between the group of contiguous OFDM symbols transmitted in one direction and the group of contiguous OFDM symbols transmitted in the other direction.

In one embodiment, the TDD frame may include a group of contiguous OFDM symbols transmitted in an upstream direction following or followed by a group of contiguous OFDM symbols transmitted in a downstream direction without a time gap between the group of contiguous OFDM symbols transmitted in one direction and the group of contiguous OFDM symbols transmitted in the other direction.

In one embodiment, the management symbol may contain acknowledgement information for retransmission, configuration information for PMD layer, or both, and wherein the configuration information for PMD layer comprises information related to FEC, bit-loading for a transmitter, bit-loading for a receiver, or any combination thereof.

In one embodiment, the management symbol may occupy a single symbol.

In one embodiment, the management symbol may include a dedicated OFDM symbol that is shared with one or more DTU(s).

In one embodiment, the processing unit may be configured to transmit the management symbol in either or both of a downstream direction and an upstream direction once per TDD frame.

In one embodiment, the processing unit may be configured to transmit the management symbol in the k^{th} symbol position in either or both of a downstream direction and an upstream direction in the TDD frame.

In one embodiment, the processing unit may be further configured to optimize the symbol position k for the management symbol based on various criteria or constraints such as retransmission latency and memory size. The retransmission latency is introduced when one or more DTUs are not received correctly by the receiver and needs to be transmitted again. The value k might not be unique and might be different for upstream and downstream direction.

In one aspect, a method may include: queuing DTUs for transmission in a TDD OFDM communication system, each of the DTUs occupying a single symbol partially or fully, or multiple symbols fully, or multiple symbols including one symbol partially, of a series of symbols in either a downstream direction or an upstream direction in a TDD frame; determining a value k, k>1, of the symbol position for a management symbol based on the constraints of: (1) a processing time including a time related to one or more of at least DTU processing, fast Fourier transform (FFT), frequency domain equalization (FEQ), forward-error-correction (FEC) code decoding and a time to generate the acknowledgement information for retransmission, and (2) a retransmission buffer size in order to optimize at least one of a retransmission latency and a payload throughput; forming the management symbol containing acknowledgement information for retransmission for transmission in a k^{th} symbol position of the series of symbols; A value of k may be non-unique and different for the downstream direction and the upstream direction. The method may also include transmitting the symbols sequentially in the TDD frame.

In one embodiment, the method may further adjust the value k of the symbol position for the management symbol based on at least one of the following constraints changes: retransmission latency and retransmission buffer size.

In one embodiment, the TDD frame may include a group of contiguous OFDM symbols transmitted in a downstream direction following or followed by a group of contiguous OFDM symbols transmitted in an upstream direction.

In one embodiment, the TDD frame may further include a time gap between the group of contiguous OFDM symbols transmitted in one direction and the group of contiguous OFDM symbols transmitted in the other direction.

In one embodiment, the management symbol may contain acknowledgement information for retransmission, configuration information for a PMD layer, or both.

In one embodiment, the configuration information for PMD layer may include information related to FEC, bit-loading for a transmitter, bit-loading for a receiver, or any combination thereof.

In one embodiment, the management symbol may occupy a single symbol.

In one embodiment, the management symbol may include a dedicated OFDM symbol that is shared with one or more DTUs.

In one embodiment, the transmitting may involve transmitting the management symbol in either or both of a downstream direction and an upstream direction once per TDD frame.

In one embodiment, the transmitting may involve transmitting the management symbol in the k^{th} symbol position in either or both of a downstream direction and an upstream direction in the TDD frame.

In another aspect, a communication device may include a memory unit and a processing unit. The memory unit may be configured to store data and one or more sets of instructions. The processing unit may be coupled to access the memory unit, and configured to execute the one or more sets of instructions to perform operations. For instance, the processing unit may queue DTUs for transmission in a TDD OFDM communication system, each of the DTUs occupying a single symbol partially or fully, or multiple symbols fully, or multiple symbols including one symbol partially, of a series of symbols in either a downstream direction or an upstream direction in a TDD frame. The processing unit may also determine a value k, k>1, of a symbol position for the management symbol based on the constraints of: (1) a processing time including a time related to one or more of at least DTU processing, fast Fourier transform (FFT), frequency domain equalization (FEQ), forward-error-correction (FEC) code decoding and a time to generate the acknowledgement information for retransmission, and (2) a retransmission buffer size in order to optimize at least one of a retransmission latency and a payload throughput; The processing may also form the management symbol containing acknowledgement information for retransmission for transmission in a k^{th} symbol position of the series of symbols. A value of k may be non-unique and different for the downstream direction and the upstream direction. The processing unit may further transmit the symbols sequentially in the TDD frame.

In one embodiment, the processing unit may also adjust the value k of the symbol position for the management symbol based on at least one of the following constraints changes: retransmission latency and retransmission buffer size.

In one embodiment, the TDD frame may include a group of contiguous OFDM symbols transmitted in a downstream direction following or followed by a group of contiguous OFDM symbols transmitted in an upstream direction.

In one embodiment, the TDD frame may further include a time gap between the group of contiguous OFDM symbols transmitted in one direction and the group of contiguous OFDM symbols transmitted in the other direction.

In one embodiment, the management symbol may contain acknowledgement information for retransmission, configuration information for a PMD layer, or both.

In one embodiment, the configuration information for PMD layer may include information related to FEC, bit-loading for a transmitter, bit-loading for a receiver, or any combination thereof.

In one embodiment, the management symbol may occupy a single symbol.

In one embodiment, the management symbol may include a dedicated OFDM symbol that is shared with one or more DTUs.

In one embodiment, in transmitting, the processing unit may transmit the management symbol in either or both of a downstream direction and an upstream direction once per TDD frame.

In one embodiment, in transmitting, the processing unit may transmit the management symbol in the k^{th} symbol position in either or both of a downstream direction and an upstream direction in the TDD frame.

This summary is provided to introduce concepts relating to repositioning a management symbol in a TDD frame. Some embodiments of the mechanism, techniques, methods, systems and devices are further described below in the detailed description. This summary is not intended to identify essential features of the claimed subject matter, nor is it intended for use in determining the scope of the claimed subject matter.

### BRIEF DESCRIPTION OF THE DRAWINGS

The accompanying drawings are included to provide a further understanding of the disclosure, and are incorporated in and constitute a part of the present disclosure. The drawings illustrate embodiments of the disclosure and, together with the description, serve to explain the principles of the disclosure.

FIG. 1 is a diagram of a G.fast frame according to the ITU-T standards up to date.

FIG. 2 is a diagram of a conventional TDD frame.

FIG. 3 is a diagram of a conventional TDD frame with a RMC symbol.

FIG. 4 is a diagram of a TDD frame with a repositioned RMC symbol in accordance with an embodiment of the present disclosure.

FIG. 5 is a diagram of repositioning a RMC symbol in a TDD frame in accordance with an embodiment of the present disclosure.

FIG. 6 is a communication device in accordance with an embodiment of the present disclosure.

FIG. 7 is a flowchart of a process in accordance with an embodiment of the present disclosure.

### DETAILED DESCRIPTION OF PREFERRED EMBODIMENTS

### Overview

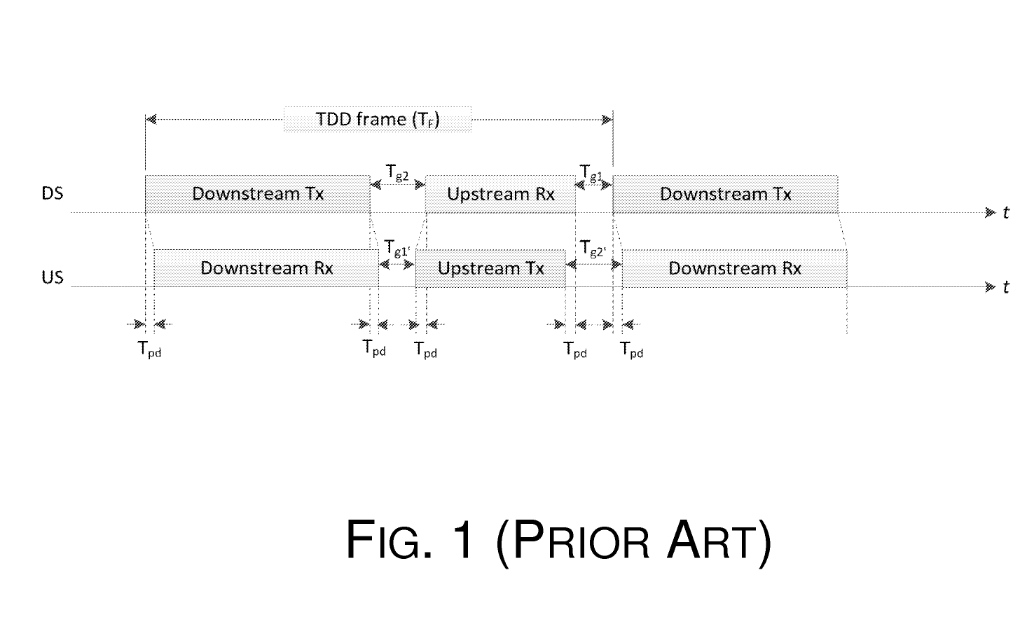

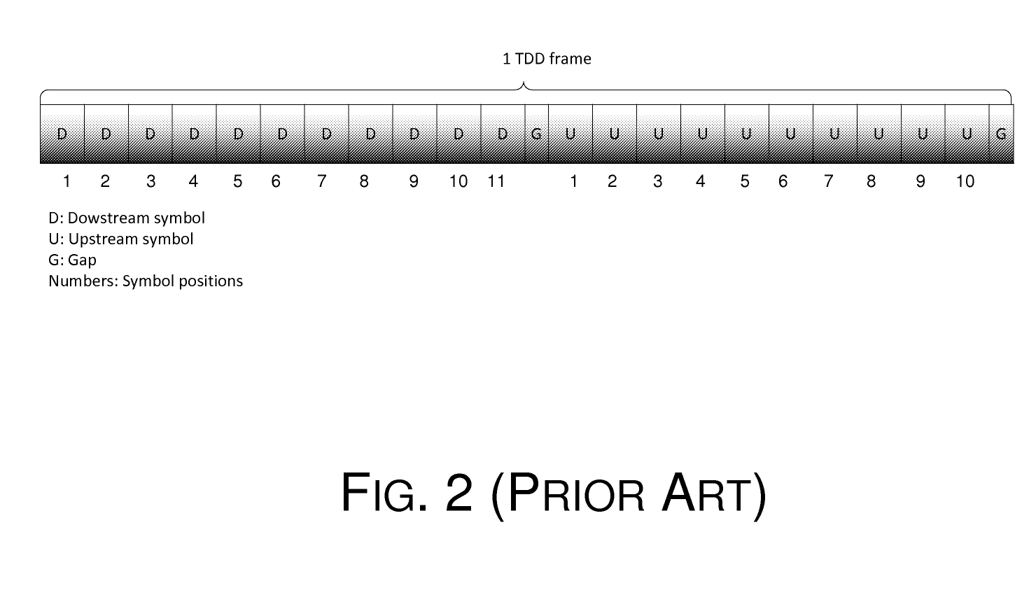

A G.fast TDD frame, or sometimes simply called a frame, is divided by upstream and downstream time slots (symbols) and might further contains some overhead such as upstream/downstream hardware switch time gaps T_{g1}, T_{g2}, T_{g1′}, T_{g2′} as illustrated in FIG. 1. The downstream transmission and upstream transmission contain an integer number of OFDM symbols. FIG. 2 illustrates a simplified TDD frame with downstream/upstream transmission symbol positions shown in the TDD frame. To simplify the diagram, it is assumed that the time gaps are the same for both downstream-to-upstream transition and upstream-to-downstream transition, which case is not necessarily true. As shown in FIG. 2, the TDD frame has a group of eleven contiguous symbol positions (numbered 1 through 11) for transmission of eleven symbols in the downstream (D) direction, and has a group of ten contiguous symbol positions (numbered 1 through 10) for transmission of ten symbols in the upstream (U) direction. FIG. 2 also shows a time gap (G) between the group of downstream symbols and the group of upstream symbols.

G.fast uses a retransmission scheme to protect the communication system against impulse noises similar to ITU-T recommendation G.998.4 for very-high-bit-rate digital subscriber line 2 (VDSL2) systems. User data (payload) are encoded into codewords (e.g., Reed-Solomon code) and then grouped and mixed with some auxiliary data to form a data transmission unit (DTU), which is a basic payload data transmission unit. The receiver either acknowledges a good reception of a DTU by sending an ACK to the transmitter or, alternatively, by sending a negative acknowledgement (NACK) to the transmitter to indicate a bad reception of a DTU.

In G.9701, an important parameter, T_{ack}, is defined for both the FTU-O and FTU-R sides as follows: The FTU shall be able to decode a received DTU and shall respond with an ACK message within T_{ack} microseconds (μsec). T_{ack} shall be measured at the U reference point from the time the last symbol carrying DTUs to be acknowledged as ended at the receiver port until the beginning of the RMC symbol carrying the acknowledgement for that ACK window at the transmitter port.

In G.fast terminologies the U interface represents the physical medium (i.e., copper wires) of the communications channel. The time T_{ack} involves a pipelined processing stages such as DTU processing, fast Fourier transform (FFT), frequency domain equalization (FEQ), forward-error-correction (FEC) code decoding, ACK/NACK data generation, constellation mapping, inverse FFT (IFFT), etc. and may consume the amount of time equivalent to multiple symbols. Although it is possible to optimize the transmitting/receiving processing stages to shorten the processing time, the amount of time required can be still significant (e.g., 4˜6 symbols). In G.9701 the maximum values of T_{ack} for both FTU-O and FTU-R are defined. For FTU-O the maximum value of T_{ack} is 400 us (about 18 symbols period) and the maximum value of T_{ack} for FTU-R is 300 us (about 14 symbols period).

If the RMC symbol is placed in the first symbol position of the transmission of a frame, it follows that the last DTUs occupying the number of symbol positions equivalent to T_{ack} that enters the U interface of a transmission in a specific direction is not acknowledged with the possibly shortest time. This may result in delayed retransmission which in turn would cause a problem of increased traffic latency. A delayed ACK might also imply a higher memory demand to store the outstanding DTUs that are not acknowledged.

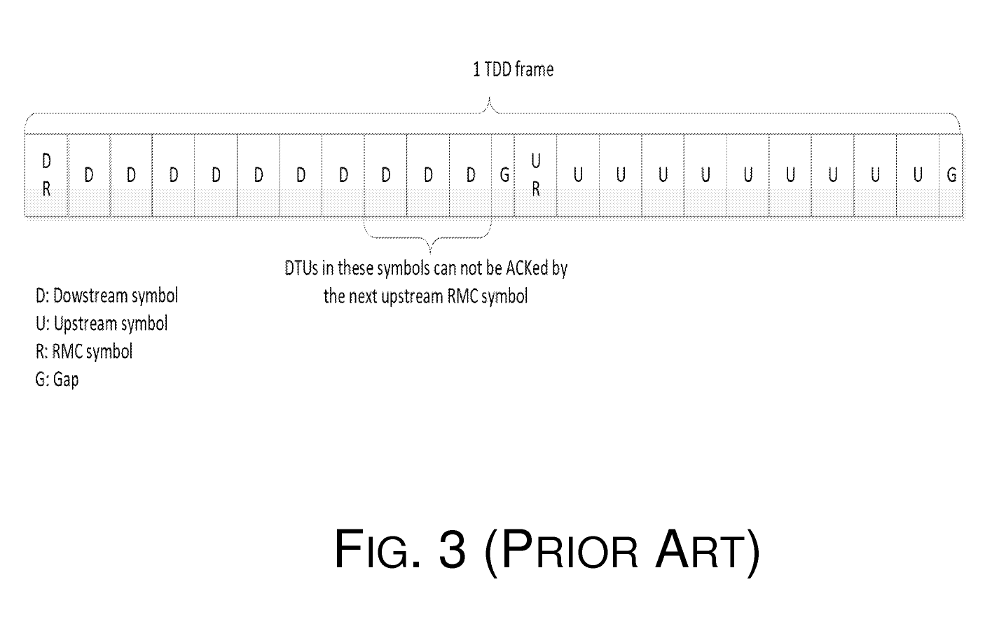

As shown in FIG. 3, a RMC symbol is placed in the first symbol position, for transmission in both the downstream and upstream directions. Assuming a T_{ack} of 4 symbols long, the DTUs transmitted in the downstream direction that are less than 4 symbols before the upstream transmission begins would not be ACKed or NACKed due to insufficient processing time.

### Example Implementation

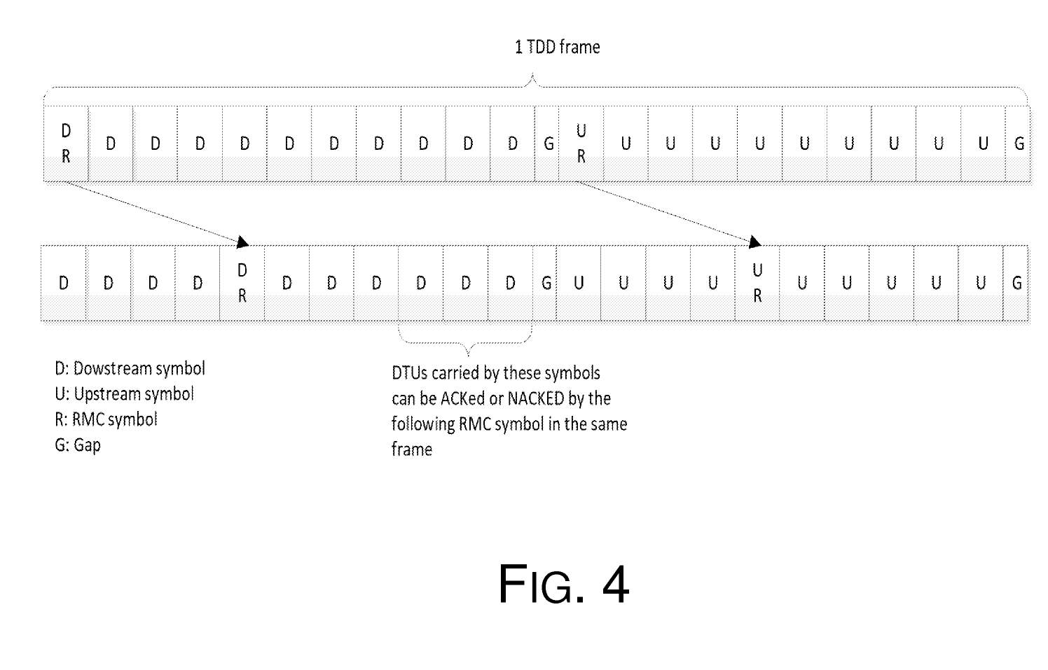

FIG. 4 illustrates a TDD frame with a repositioned RMC symbol in accordance with an embodiment of the present disclosure.

By shifting the RMC symbol position to be larger or equal to T_{ack}, the aforementioned problem can be solved completely. By repositioning the RMC symbol in a TDD frame, the retransmission latency can be minimized. Notably, the technique is applicable to both the downstream and upstream directions.

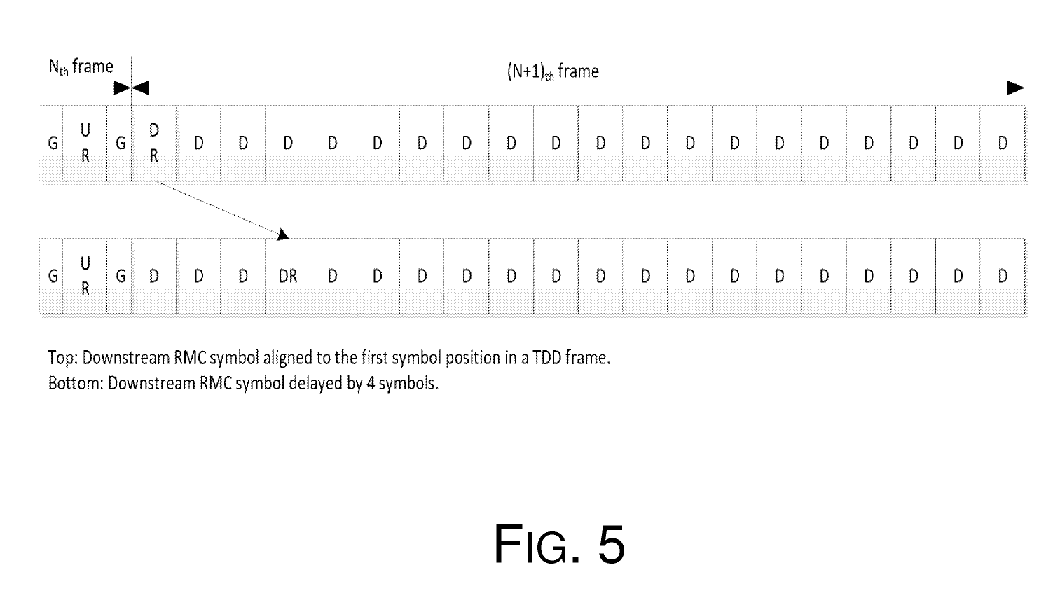

FIG. 5 illustrates repositioning of a RMC symbol in a TDD frame in accordance with an embodiment of the present disclosure.

More specifically, FIG. 5 shows another example that demonstrates how the delayed RMC symbol will help improve the retransmission performance. In this extremely asymmetric example, only one symbol is allocated to the upstream direction in a TDD frame. Consequently, the position of the upstream RMC symbol is not optimum. This degrades the performance of the downstream retransmission mechanism. However, by delaying the RMC symbol in the downstream direction, the latency in the upstream direction can be reduced by one full frame when retransmission occurs.

In FIG. 5, the top frame represents a frame with the RMC symbol aligned to the first symbol position in the downstream direction. Assuming some DTUs are transmitted in the upstream symbol in the n^{th} frame, the DTUs cannot be ACKed or NACKed by the RMC symbol in the (N+1)^{th} frame due to insufficient processing time. If the downstream RMC symbol in the (N+1)^{th} frame is delayed by 4 symbols as shown in the bottom frame then all DTUs sent in the upstream symbol in the N^{th} frame can be ACKed or NACKed by the RMC symbol in the (N+1)^{th} frame. This advantageously saves one frame of latency under retransmission.

### Example Device

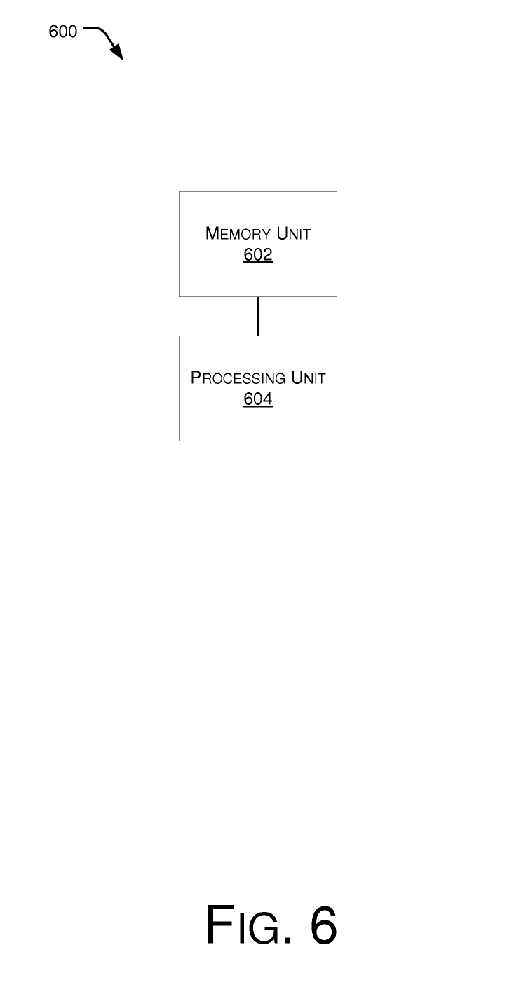

FIG. 6 illustrates a communication device 600 in accordance with an embodiment of the present disclosure.

Communication device 600 is configured to implement systems and methods in accordance with the present disclosure. Communication device 600 includes a memory unit 602 and a processing unit 604. Communication device 600 may be, for example, a communication processor or chipset implemented in a communication apparatus such as a gateway, router, switch or the like in a TDD OFDM communication system. In some embodiments, communication device 600 includes more than one processing unit 604 and/or more than one memory unit 602. For simplicity, the description hereinafter refers to examples in which communication device 600 includes one processing unit 604 that performs the described operations.

In one example, the memory unit 602 may be configured to store data, one or more sets of instructions, or both. The processing unit 604 may be coupled to access the memory unit 602, and may be configured to execute the one or more sets of instructions to perform a number of operations. The operations may include: queuing DTUs for transmission in a TDD OFDM communication system, each of the DTUs occupying a single symbol partially or fully, or multiple symbols, of a series of contiguous symbols in a TDD frame; forming a management symbol, e.g., a RMC symbol, for transmission in a k^{th} symbol position of the series of symbols, k>1; and transmitting the symbols sequentially in the TDD frame.

In one embodiment, the TDD frame may include a group of contiguous OFDM symbols transmitted in a downstream direction following or followed by (i.e., transmitted after or before) a group of contiguous OFDM symbols transmitted in an upstream direction with a time gap between the group of contiguous OFDM symbols transmitted in one direction and the group of contiguous OFDM symbols transmitted in the other direction.

In one embodiment, the TDD frame may include a group of contiguous OFDM symbols transmitted in an upstream direction following or followed by (i.e., transmitted after or before) a group of contiguous OFDM symbols transmitted in a downstream direction without a time gap between the group of contiguous OFDM symbols transmitted in one direction and the group of contiguous OFDM symbols transmitted in the other direction.

In one embodiment, the management symbol may contain acknowledgement information for retransmission, configuration information for PMD layer, or both, and wherein the configuration information for PMD layer comprises information related to FEC, bit-loading for a transmitter, bit-loading for a receiver, or any combination thereof.

In one embodiment, the management symbol may occupy a single symbol.

In one embodiment, the management symbol may include a dedicated OFDM symbol that is shared with one or more DTUs.

In one embodiment, the processing unit 604 may be configured to transmit the management symbol in either or both of a downstream direction and an upstream direction once per TDD frame.

In one embodiment, the processing unit 604 may be configured to transmit the management symbol in the k^{th} symbol position in either or both of a downstream direction and an upstream direction in the TDD frame.

In one embodiment, the processing unit 604 may be further configured to optimize the symbol position k for the management symbol based on various criteria or constraints such as retransmission latency and memory size. The value k might not be unique and might be different for upstream and downstream directions.

### Example Process

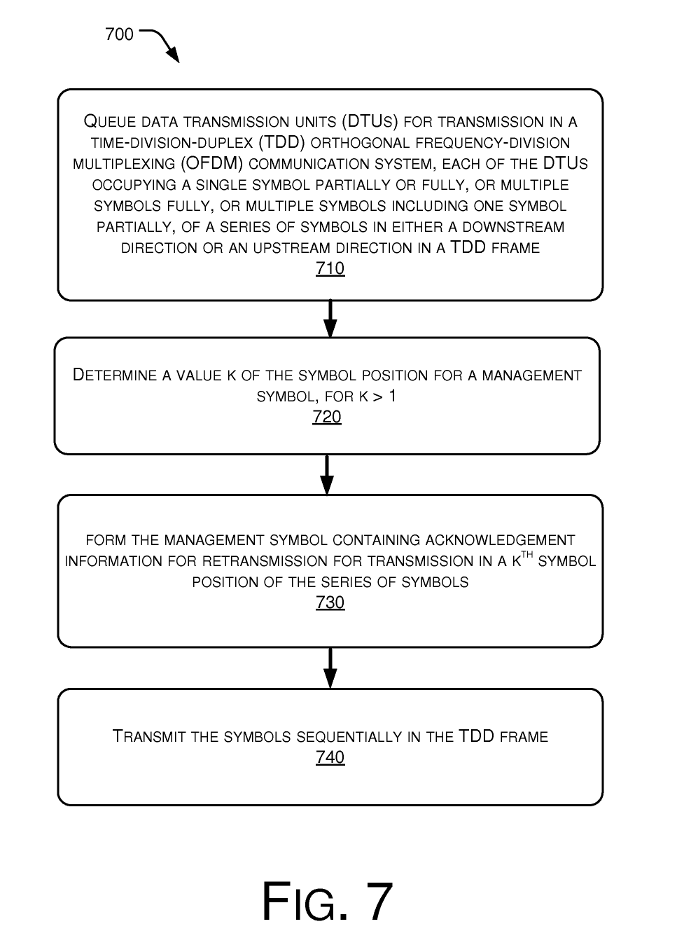

FIG. 7 is a flowchart of a process 700 in accordance with an embodiment of the present disclosure. Process 700 includes one or more operations, actions, or functions as illustrated by one or more of blocks 710, 720, 730 and 740. Although illustrated as discrete blocks, various blocks may be divided into additional blocks, combined into fewer blocks, or eliminated, depending on the desired implementation. Process 700 may be implemented by one or more processors including, for example, processing unit 604 of communication device 600. Moreover, some or all of the operations of process 700 may be carried out by processing unit 604. For illustrative purposes, the operations described below are performed by processing unit 604 of communication device 600 as shown in FIG. 6. Process 700 may begin at block 710.

At 710, process 700 may involve processing unit 604 queuing DTUs for transmission in a TDD OFDM communication system. Each of the DTUs may occupy a single symbol partially or fully, or multiple symbols fully, or multiple symbols including one symbol partially, of a series of symbols in either a downstream direction or an upstream direction in a TDD frame. Block 710 may be followed by block 720.

At 720, process 700 may involve processing unit 604 determining a value k, k>1, of the symbol position for a management symbol based on the constraints of: (1) a processing time including a time related to one or more of at least DTU processing, fast Fourier transform (FFT), frequency domain equalization (FEQ), forward-error-correction (FEC) code decoding and a time to generate the acknowledgement information for retransmission, and (2) a retransmission buffer size in order to optimize at least one of a retransmission latency and a payload throughput. A value of k may be non-unique and can be different for the downstream direction and the upstream direction. Block 720 may be followed by block 730.

At 730, process 700 may involve processing unit 604 forming the management symbol containing acknowledgement information for retransmission for transmission in a k^{th} symbol position of the series of symbols. Block 730 may be followed by block 740.

At 740, process 700 may involve processing unit 604 transmitting the symbols sequentially in the TDD frame.

In one embodiment, the method may further adjust the value k of the symbol position for the management symbol based on at least one of the following constraints changes: retransmission latency and retransmission buffer size.

In one embodiment, the TDD frame may include a group of contiguous OFDM symbols transmitted in a downstream direction following or followed by a group of contiguous OFDM symbols transmitted in an upstream direction.

In one embodiment, the TDD frame may further include a time gap between the group of contiguous OFDM symbols transmitted in one direction and the group of contiguous OFDM symbols transmitted in the other direction.

In one embodiment, the management symbol may contain acknowledgement information for retransmission, configuration information for a PMD layer, or both.

In one embodiment, the configuration information for PMD layer may include information related to FEC, bit-loading for a transmitter, bit-loading for a receiver, or any combination thereof.

In one embodiment, the management symbol may occupy a single symbol.

In one embodiment, the management symbol may include a dedicated OFDM symbol that is shared with one or more DTUs.

In one embodiment, the transmitting may involve transmitting the management symbol in either or both of a downstream direction and an upstream direction once per TDD frame.

In one embodiment, the transmitting may involve transmitting the management symbol in the k^{th} symbol position in either or both of a downstream direction and an upstream direction in the TDD frame.

### Additional Notes

Embodiments of the present disclosure are not limited to those described herein. The actual design and implementation of the proposed techniques, methods, devices and systems in accordance with the present disclosure may vary from the embodiments described herein. Those ordinarily skilled in the art may make various deviations and improvements based on the disclosed embodiments, and such deviations and improvements are still within the scope of the present disclosure. Accordingly, the scope of protection of a patent issued from the present disclosure is determined by the claims as follows.

In the above description of exemplary implementations, for purposes of explanation, specific numbers, materials configurations, and other details are set forth in order to better explain the present disclosure, as claimed. However, it will be apparent to one skilled in the art that the claimed subject matter may be practiced using different details than the exemplary ones described herein. In other instances, well-known features are omitted or simplified to clarify the description of the exemplary implementations.

What is claimed is:

1. A method, comprising:
queuing data transmission units (DTUs) for transmission in a time-division-duplex (TDD) orthogonal frequency-division multiplexing (OFDM) communication system, each of the DTUs occupying a single symbol partially or fully, or multiple symbols fully, or multiple symbols including one symbol partially, of a series of symbols in either a downstream direction or an upstream direction in a TDD frame;
determining a value k, k>1, of the symbol position for a management symbol based on the constraints of:
a processing time including a time related to one or more of at least DTU processing, fast Fourier transform (FFT), frequency domain equalization (FEQ), forward-error-correction (FEC) code decoding and a time to generate the acknowledgement information for retransmission; and
a retransmission buffer size in order to optimize at least one of a retransmission latency and a payload throughput, wherein a value of k is non-unique and different for the downstream direction and the upstream direction;
forming the management symbol containing acknowledgement information for retransmission for transmission in the k^{th} symbol position of the series of symbols; and
transmitting the symbols sequentially in the TDD frame.

2. The method of claim 1, further comprising:
adjusting the value k of the symbol position for the management symbol based on at least one of the following constraints changes: retransmission latency and retransmission buffer size.

3. The method of claim 1, wherein the TDD frame comprises a group of contiguous OFDM symbols transmitted in a downstream direction following or followed by a group of contiguous OFDM symbols transmitted in an upstream direction.

4. The method of claim 1, wherein the TDD frame further comprises a time gap between the group of contiguous OFDM symbols transmitted in one direction and the group of contiguous OFDM symbols transmitted in the other direction.

5. The method of claim 1, wherein the management symbol contains acknowledgement information for retransmission, configuration information for a physical medium dependent (PMD) layer, or both.

6. The method of claim 5, wherein the configuration information for PMD layer comprises information related to forward error correction (FEC), bit-loading for a transmitter, bit-loading for a receiver, or any combination thereof.

7. The method of claim 1, wherein the management symbol occupies a single symbol.

8. The method of claim 1, wherein the management symbol comprises a dedicated OFDM symbol that is shared with one or more DTUs.

9. The method of claim 1, wherein the transmitting comprises transmitting the management symbol in either or both of a downstream direction and an upstream direction once per TDD frame.

10. The method of claim 1, wherein the transmitting comprises transmitting the management symbol in the k^{th} symbol position in either or both of a downstream direction and an upstream direction in the TDD frame.

11. A communication device, comprising:
a memory unit configured to store data and one or more sets of instructions; and
a processing unit coupled to access the memory unit, the processing unit configured to execute the one or more sets of instructions to perform operations comprising:
queuing data transmission units (DTUs) for transmission in a time-division-duplex (TDD) orthogonal frequency-division multiplexing (OFDM) communication system, each of the DTUs occupying a single symbol partially or fully, or multiple symbols fully, or multiple symbols including one symbol partially, of a series of symbols in either a downstream direction or an upstream direction in a TDD frame;
determining a value k, k>1, of a symbol position for a management symbol based on the constraints of:
a processing time including a time related to one or more of at least DTU processing, fast Fourier transform (FFT), frequency domain equalization (FEQ), forward-error-correction (FEC) code decoding and a time to generate the acknowledgement information for retransmission; and
a retransmission buffer size in order to optimize at least one of a retransmission latency and a payload throughput, wherein a value of k is non-unique and different for the downstream direction and the upstream direction;
forming the management symbol containing acknowledgement information for retransmission for transmission in a k^{th} symbol position of the series of symbols; and
transmitting the symbols sequentially in the TDD frame.

12. The communication device of claim 11, further comprising:
adjusting the value k of the symbol position for the management symbol based on at least one of the following constraints changes: retransmission latency and retransmission buffer size.

13. The communication device of claim 11, wherein the TDD frame comprises a group of contiguous OFDM symbols transmitted in a downstream direction following or followed by a group of contiguous OFDM symbols transmitted in an upstream direction.

14. The communication device of claim 11, wherein the TDD frame further comprises a time gap between the group of contiguous OFDM symbols transmitted in one direction and the group of contiguous OFDM symbols transmitted in the other direction.

15. The communication device of claim 11, wherein the management symbol contains acknowledgement information for retransmission, configuration information for a physical medium dependent (PMD) layer, or both.

16. The communication device of claim 15, wherein the configuration information for PMD layer comprises information related to forward error correction (FEC), bit-loading for a transmitter, bit-loading for a receiver, or any combination thereof.

17. The communication device of claim 11, wherein the management symbol occupies a single symbol.

18. The communication device of claim 11, wherein the management symbol comprises a dedicated OFDM symbol that is shared with one or more DTUs.

19. The communication device of claim 11, wherein the transmitting comprises transmitting the management symbol in either or both of a downstream direction and an upstream direction once per TDD frame.

20. The communication device of claim 11, wherein the transmitting comprises transmitting the management symbol in the k^{th} symbol position in either or both of a downstream direction and an upstream direction in the TDD frame.
